(19) United States
(12) Patent Application Publication
(10) Pub. No.: US 2010/0157502 A1
(43) Pub. Date: Jun. 24, 2010

(54) System for decoupling a power source from a load

(75) Inventors: David Alan Hale, Chillicothe, IL (US); Bryan Anthony Lavezzi, Hanna City, IL (US); Sarah Elizabeth Schonert, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/316,933

(22) Filed: Dec. 18, 2008

(51) Int. Cl. H01H 47/00; H01H 3/54

(52) U.S. Cl. 361/170; 200/329

(57) ABSTRACT

A relay switch decoupler is disclosed. The relay switch decoupler may include a first contact, and a second contact selectively coupled to the first contact. The relay switch decoupler may further include an insulating decoupler situated proximate to the first contact and the second contact. The relay switch decoupler may further include an actuator coupled to the insulating decoupler and configured to cause the insulating decoupler to decouple the first contact from the second contact in response to a control signal.

### TECHNICAL FIELD

The present disclosure relates generally to a system for decoupling a power source from a load, and, more particularly, to a system for decoupling a power source from a load when a relay switch fails in a closed position.

### BACKGROUND

A relay switch is an electrical switch that may operate (i.e., open and close) based on an electronic control signal. For example, if a relay switch is closed (i.e., on), electrical current may be allowed to flow through a system. If a relay switch is open (i.e., off), no electrical current may flow through the system.

In one embodiment, a relay switch may include a coil associated with an armature, a moving contact mechanically coupled to the armature, and a fixed contact. When a controller associated with the relay switch directs current to the coil, a resulting magnetic field generated in the coil may attract the armature. Since the moving contact is mechanically coupled to the armature, the attraction may be used to couple the moving contact with the fixed contact. The coupling of the two contacts may allow electrical current to flow from a power source to a load. When the control module stops supplying current to the coil, the magnetic field discontinues and the moving contact may be returned to its relaxed state by a force such as, for example, a spring or gravity. Consequently, the electrical connection between the power source and the load is interrupted, preventing current flow from the power source to the load.

Relay switches, like most electromechanical devices, tend to fail after a finite number of iterations. The failure of the relay switch may result from repeated arcing associated with switching the relay between on and off positions. For example, as a relay is switched between on and off positions the movable contact becomes disconnected from the fixed contact and begins to retract to its rest state. Immediately after disconnect, the high voltage potential between the movable contact and the fixed contact may cause arcing in the small gap that is created as the movable contact retracts to its resting state. Over time, such electrical arcing may degrade the material of the contacts. Eventually, this degradation may weaken the tolerance of one or more of the contacts to the high temperatures caused by the arcing, potentially causing the “welding” together of the two contacts. If the contacts become “welded” together, the mechanism used to return the movable contact to its relaxed state may not have enough force to separate the contacts, essentially short-circuiting the power source to the load. If a relay switch fails in a closed position, a power source associated with a load could erroneously continue supplying power to the load, causing an undue loss in power from the power source and, potentially, leading to damage to the machine or its constituent components and subsystems.

One system for decoupling a power source from a load when a relay switch fails in a closed position is disclosed in U.S. Pat. No. 4,243,964 (the '964 patent), issued to Bögner et al. The '964 patent discloses an electromagnetically-operated switch that may effectively disconnect a movable contact bridge from contact terminals, even though the movable contact bridge may be stuck to the contact terminals. Specifically, the '964 patent discloses a housing comprising, among other things, a movable contact bridge that may, when desired, connect to contact terminals to complete a circuit. In some situations, the movable contact bridge may stick to one or both of the contact terminals, which may cause the switch to fail in the closed position. If this should happen, a series of mechanical components (e.g., a spring, a sleeve, a bolt or rod, a ring, etc.) may cooperate to physically exert a blow against the movable contact bridge, thereby dislodging it from the contact terminals.

Although the system of the '964 patent may decouple switch contacts that have failed in a closed position in certain situations, the '964 patent may be insufficient and unreliable. For example, the mechanism of the system of the '964 patent that dislodges the movable contact bridge from the contact terminals, which is part of the solenoid switch assembly that couples the moveable contact bridge to the contact terminals, uses the same spring that provides the opposable force to return the solenoid to its “rest” position to create the force for decoupling the moveable contact bridge from the contact terminals. Because the strength of this spring must be limited so as to enable solenoid movement under normal operation, it may, in certain situations, provide insufficient force to break the “welding” force between the moveable contact bridge and the contact terminals. Furthermore, as the solenoid device ages, the spring strength (i.e., the negative force exerted by compression of the spring) may be weakened, potentially limiting the ability of the spring to provide sufficient force to break “welded” contacts and potentially limiting the overall reliability of the decoupling mechanism. Thus, in order to provide a solution for disconnecting electrical circuits when a relay switch fails in a closed position, a selectively actuated decoupling device that is operable independent of the operation of the relay switch, may be desirable.

The disclosed system and method is directed towards improving existing relay switching systems.

### SUMMARY

An aspect of the present disclosure is directed to a relay switch decoupler. The relay switch decoupler may include a first contact, and a second contact selectively coupled to the first contact. The relay switch decoupler may further include an insulating decoupler situated proximate to the first contact and the second contact. The relay switch decoupler may further include an actuator coupled to the insulating decoupler and configured to cause the insulating decoupler to decouple the first contact from the second contact in response to a control signal.

Another aspect of the present disclosure is directed to a method for decoupling a power source from a load. The method may include monitoring a power available to the load. The method may further include monitoring a switch signal associated with a relay switching system. The method may further include selectively providing a control signal to an actuator, wherein the actuator is configured to cause an insulating decoupler to decouple the power source from the load in response to the control signal.

Another aspect of the present disclosure is directed to a relay switching system. The system may include a power source and a load. The system may further include a relay switch configured to electrically couple the power source to the load. The relay switch may include an insulating decoupler. The relay switch may further include an actuator coupled to the insulating decoupler and configured to cause the insulating decoupler to decouple the power source from the load in response to a control signal.

### BRIEF DESCRIPTION OF THE DRAWINGS

FIG. 1 is a diagrammatic illustration of a machine according to exemplary disclosed embodiments;

FIG. 2 is diagrammatic illustration of an exemplary relay switch decoupler that may be associated with the machine of FIG. 1; and

FIG. 3 is a block diagram illustrating an exemplary method for controlling the relay switch decoupler of FIG. 2.

### DETAILED DESCRIPTION

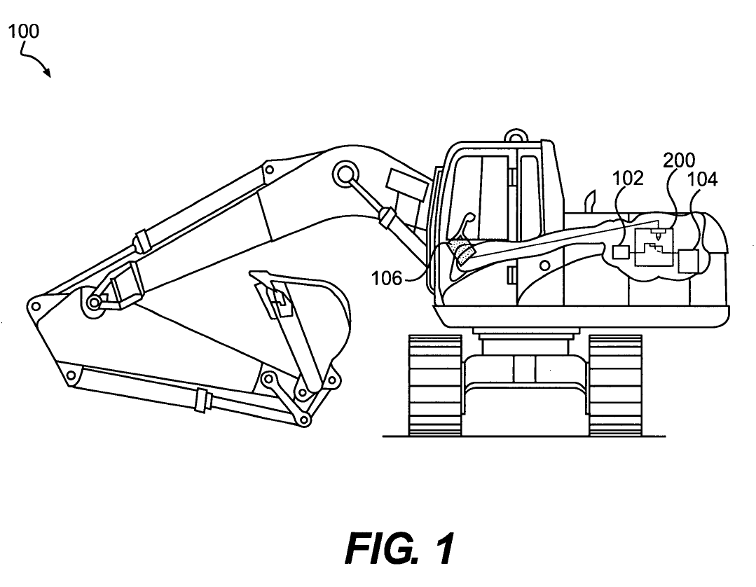

FIG. 1 illustrates an exemplary machine 100, on which the presently disclosed systems and methods for decoupling a power source from a load may be implemented. Machine 100 may be any type of machine that performs some type of operation associated with an industry such as mining, construction, farming, transportation, etc. For example, machine 100 may be an earth moving machine such as an excavator, a dozer, a loader, a backhoe, or a tractor. Additionally, although FIG. 1 illustrates machine 100 as being a mobile earth-moving machine, it is contemplated that machine 100 may be another type of machine such as, for example, a mobile or stationary generator. Indeed, any type of machine or system that uses relay switches may employ the disclosed embodiments and their equivalents. Machine 100 may include a power source 102, a load 104, and a controller 106.

Power source 102 may be any suitable electrical power supplying device such as, for example, a battery, an electrical generator, a fuel cell, an alternator, etc. Load 104 may be any suitable electrical load component(s), such as, for example, heating elements, lights, motors, etc. Controller 106 may include one or more processing devices (not shown), and memory devices for storing data executed by the processing devices (not shown). In one embodiment, controller 106 may include software that is stored in a rewritable memory device, such as a flash memory. It will be understood that controller 106 may contain additional and/or different components than those listed above. For example, controller 106 may include one or more other components or sub-systems such as, for example, power supply circuitry, signal conditioning circuitry, solenoid circuitry, and/or any other suitable circuitry for aiding in the control of one or more systems of machine 100. Machine 100 may further include a relay switch decoupler 200 communicatively coupled to controller 106. Relay switch decoupler 200 may be configured to decouple a power source from a load if a relay switch fails in a closed position (i.e., if the contacts of a relay switch become stuck together).

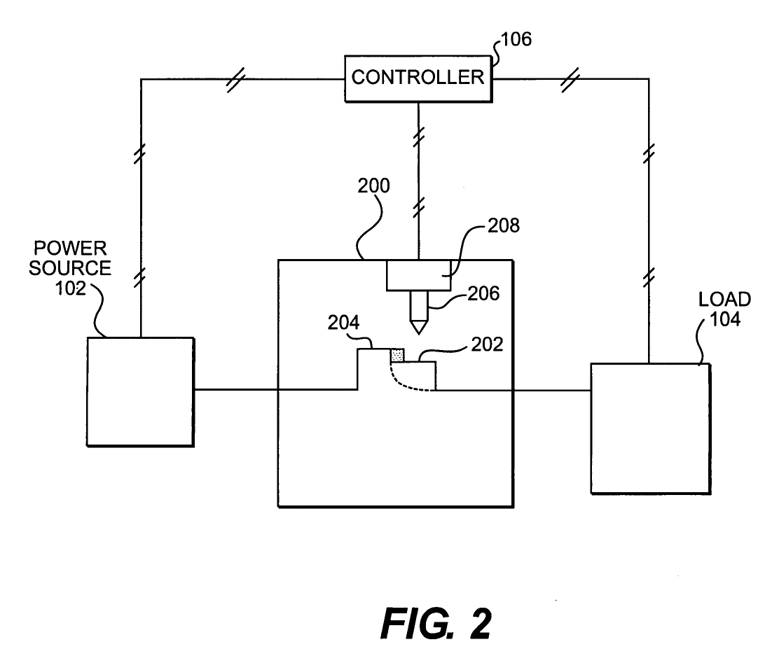

FIG. 2 illustrates an embodiment of an exemplary relay switch decoupler 200. As illustrated in FIG. 2, relay switch decoupler 200 may include a movable contact 202 and a fixed contact 204. In one embodiment, movable contact 202 may be mechanically coupled to an armature associated with a coil (both not shown). Upon receipt of a command signal to activate load 104, controller 106 may send a switch signal to the coil associated with the armature. The switch signal may result in an induction of a magnetic field in the coil, which is positioned about the armature such that induction of the magnetic field interacts with metallic material in the armature to generate an attractive force on the armature.

Since the movable contact 202 may be mechanically coupled to the armature, the attraction may be used to couple the movable contact 202 with the fixed contact 204. The coupling of the movable contact 202 with the fixed contact 204 may create an electrical connection between power source 102 and load 104, thereby allowing power to flow from power source 102 to load 104. Upon receipt of a command signal to de-activate load 104, controller 106 may turn off the switch signal, resulting in the discontinuation of the magnetic field, and the movable contact 202 being returned to its relaxed state by a force such as, for example, a spring or gravity.

It is contemplated that movable contact 202 and fixed contact 204 may have additional and/or different configurations than are shown. For example, in one embodiment, movable contact 202 may be a set of movable contacts (i.e., a movable contact bridge), with fixed contact 204 being a set of stationary contacts to which movable contacts 202 may be selectively coupled. Movable contact 202 and fixed contact 204 may comprise any suitable conductive material such as, for example, copper, aluminum, graphite, etc.

Relay switch decoupler 200 may further include an insulating decoupler 206 and an actuator 208. Insulating decoupler 206 and actuator 208 may cooperate to decouple movable contact 202 from fixed contact 204 if movable contact 202 and fixed contact 204 become improperly short-circuited together. For example, the material of movable contact 202 and fixed contact 204 may degrade as a result of electrical arcing associated with the switching of the movable contact 202. This degradation may weaken the tolerance of one or more of the contacts to the high temperatures caused by the arcing, potentially causing the “welding” together of the movable contact 202 and the fixed contact 204. If the movable contact 202 and the fixed contact 204 become welded together, the mechanism used to the return the movable contact 202 to its relaxed state may not have enough force to separate the movable contact 202 from the fixed contact 204. If this should occur, controller 106 may send a control signal to activate actuator 208. Consequently, actuator 208 may force/project insulating decoupler 206 against movable contact 202, thereby decoupling movable contact 202 and fixed contact 204. It is contemplated that insulating decoupler 206 will not retract after it has been activated. That is, it is contemplated that, after insulating decoupler 206 has been forced into movable contact 202, insulating decoupler 206 will stay lodged between movable contact 202 and fixed contact 204, thereby ensuring that movable contact 202 and fixed contact 204 do not become coupled back together.

Insulating decoupler 206 may comprise any suitable, substantially non-conductive material such as, for example, plastic, glass, porcelain, rubber, epoxy, and/or a composite polymer material. Furthermore, insulating decoupler may, in some cases, be formed by semi-conductive materials insofar as such materials do not facilitate the flow of current between moveable contact 202 and fixed contact 204 when insulating decoupler 206 is engaged between moveable contact 202 and fixed contact 204. Accordingly, “non-conductive” as the term is used herein, refers to the inability of current to pass from moveable contact 202, through insulating decoupler 206, to fixed contact 204 (or vice versa) such that insulating decoupler 206 is providing a significant current path between moveable contact 202 and insulating decoupler 206. Thus, in describing insulating decoupler 206 as comprising “non-conductive” material, it is not necessary that insulating decoupler 206 have infinite resistance. Rather, insulating decoupler 206 may comprise materials that ensure that the resistance of insulting decoupler 206 is sufficiently large to prevent significant current flow between moveable contact 202 and fixed contact 206.

Furthermore, insulating decoupler 206 may be of any suitable shape, strength, and material sufficient to dislodge moveable contact 202 from electrical contact with fixed contact 204. Accordingly, specific design of insulating decoupler 206 will depend upon the size, shape, type, and method of operation of the relay switch in which it is employed. Specifically, the shape of insulating decoupler 206 may depend on the position of moveable contact 202 within the relay, the shape of the relay components and/or its constituent components (e.g., moveable contact 202), and the material of insulating decoupler 206. It is therefore contemplated that there may be many suitable combinations of sizes, shapes, types, and materials associated with insulating decoupler 206 depending upon the specific design of the relay switch in which it is employed. It should be noted that, insulating decoupler 206, when deployed, needs to be sufficiently strong enough and large enough to keep the contactors from coming into electrical contact with one another. Thus, the shape and size of insulating decoupler 206 illustrated in the drawings is exemplary only, and not intended to be limiting. For example, although illustrated in FIG. 2 as containing a pointed tip, insulating decoupler 206 may include a blunt-tip, flat-tip, or any other tip suitable to de-couple moveable contact 202 from fixed contact 204.

Actuator 208 may embody any suitable device or substance that may, when activated or appropriately stimulated, move, propel, or otherwise operate on insulating decoupler 206 in a manner sufficient to cause insulating decoupler 206 to separate moveable contact 202 and fixed contact 204. Specifically, actuator 208 may, when operated, release a force sufficient to cause insulating decoupler 206 to interact with a moveable contact 202 in such a way as to force moveable contact 202 away from fixed contact 204. The force released by the operation of actuator 208 may be predetermined, based primarily on the expected strength of a bond that is established between moveable contact 202 and fixed contact 204. According to one exemplary embodiment, actuator 208 may be designed to overcome an arc-welded bond the may be formed between moveable contact 202 and fixed contact 204 due to the breakdown of surface material of one or more of moveable contact 202 and fixed contact 204. Of course, because the strength of such a bond is highly dependent upon the materials used for moveable contact 202 and fixed contact 204, as well as the current available to produce such an arc-weld (i.e., the operating current of the relay switch), actuator 208 may be designed to exert a larger force than is required to “break” such bonds. It is contemplated that the force exerted by actuator 208 may be adjusted and varied, depending upon one or more of: a physical characteristic (e.g., size, weight, material, etc.) of moveable contact 202 and/or fixed contact 204, the force with which moveable contact 202 and fixed contact 204 engage one another, the current rating of the relay switch in which it operates, etc. Thus, actuator 208 may be of any suitable size, type, shape, and may be designed to provide any force value sufficient to separate moveable contact 202 and fixed contact 204, consistent with the design of the relay switch within which it may be employed.

In one embodiment, actuator 208 may be a compartment that contains a pyrotechnic composition (e.g., a powder charge) that, when ignited, will produce an explosive force that may be harnessed to direct insulating decoupler 206 into movable contact 202 with sufficient force to disconnect movable contact 202 from fixed contact 204, thereby decoupling power source 102 from load 104. It is contemplated that if actuator 208 is a compartment that contains a pyrotechnic composition, the control signal may operate an ignition device, so that when the control signal is applied to the ignition device, the pyrotechnic composition is ignited, causing insulating decoupler 206 to decouple power source 102 from load 104.

In another embodiment, actuator 208 may be a device such as, for example, a compressed spring that may be coupled to insulating decoupler 206. Consequently, when the compressed spring is released from its compressed state in response to a control signal by controller 106, a resulting force may cause insulating decoupler 206 to be forced against movable contact 202, thus decoupling movable contact 202 from fixed contact 204. Again, it is contemplated that in the embodiments described above, insulating decoupler 206 will stay lodged between movable contact 202 and fixed contact 204, thereby ensuring that movable contact 202 and fixed contact 204 do not become coupled back together.

It is understood that the above examples of insulating decoupler 206 and actuator 208 are exemplary only and not intended to be limiting. For example, it is contemplated that actuator 208 may be any type of device that uses stored energy to cause insulating decoupler 206 to be forced against movable contact 202, thus decoupling movable contact 202 from fixed contact 204. Moreover, other embodiments, including combining insulating decoupler 206 and actuator 208 into one element may be desired.

In the embodiment of FIG. 2, controller 106 may determine when to activate actuator 208 by continuously monitoring the switch signal applied to relay switch decoupler 200, and the voltage available to load 104. If power is available to load 104 while the switch signal is turned off (indicating that power source 102 is improperly supplying power to load 104 when the circuit should be disconnected), controller 106 may send a control signal to actuator 208, which activates actuator 208 causing insulating decoupler 206 to decouple power source 102 and load 104.

In one embodiment, controller 106 may wait an amount of time before determining if power is available to load 104. Such a delay may allow residual power that may be available to load 104 to dissipate, thereby avoiding an erroneous detection of a short-circuit condition and inadvertent activation of actuator 208. As an example, in situations where relay switch decoupler 200 comprises a solenoid switch (e.g., an electromagnetically-controlled armature switch), a switch current may be applied to a coil of wire wound around the armature, inducing operation of the armature switch for selectively coupling power source 102 to load 104. Due to the inductive properties of the coil used to induce the electromagnetic field for moving the armature, when the switch signal is turned off, residual current (and, therefore, the electromagnetic field used to “hold in” the armature switch) in the coil does not immediately dissipate, which may cause a delay in the armature switch response to the switch signal. Therefore, in some embodiments, if controller 106 determines the power associated with load 104 without compensating for the switch response, controller 106 may erroneously detect power available to load 104 when the switch signal is off and, as a result, inadvertently activate actuator 208.

In another embodiment, controller 106 may require the switch signal to be below a first threshold value (e.g., 1 volt), and the power available to load 104 to be above a second threshold value (e.g., 2 volt) before activating actuator 208. This may also ensure that actuator 208 is not activated inadvertently by dissipating voltage.

It is contemplated that relay switch decoupler 200 may include additional and/or different components than are disclosed. It is further contemplated that relay switch decoupler 200 may have other configurations. Moreover, although FIG. 1 illustrates a single relay switch decoupler 200 associated with machine 100, it is contemplated that more than one relay switch decoupler 200 may be implemented on machine 100. For example, in one embodiment, machine 100 may have a single power source 102 and a plurality of loads 104. In this embodiment, each load 104 may be coupled to the power source 102 via a separate relay switch decoupler 200.

### INDUSTRIAL APPLICABILITY

The disclosed system and method may be applicable to any machine or system where relay switching systems are deployed to selectively couple a power source and a load. The disclosed system and method may be desirable in any application where relay failure may create an unexpected, uncontrollable, and potentially damaging short circuit condition between a moveable contact and a fixed contact.

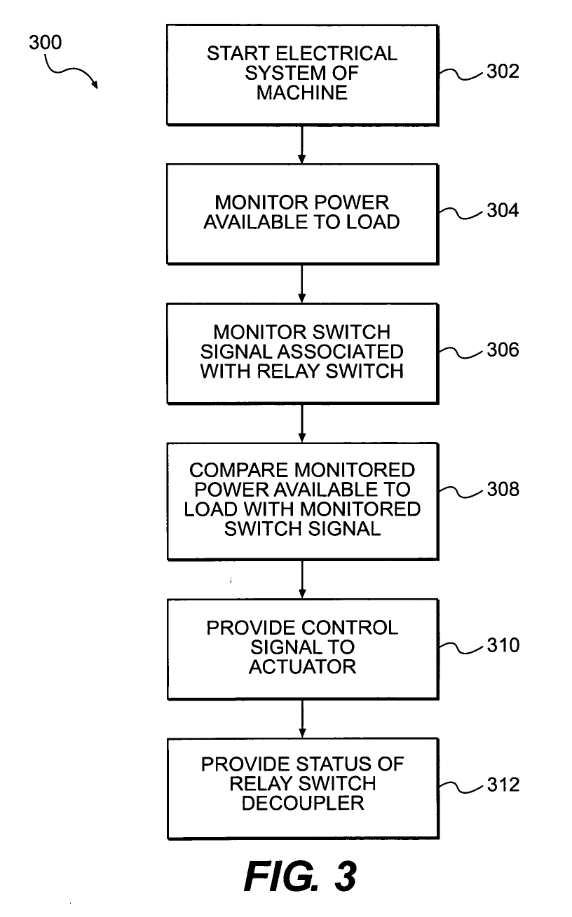

FIG.3 shows a flowchart 300 illustrating a process for controlling relay switch decoupler 200 consistent with the disclosed embodiments and their equivalents. As illustrated in FIG. 3, the process may be initiated upon start-up of the electrical system of machine 100 (Step 302). Specifically, relay switch decoupler 200 may be responsively to activation of the electrical system within which it is installed. As a function of the work cycle of machine 100, power source 102 and load 104 may be selectively coupled via relay switch decoupler 200.

For example, in one embodiment, an operator of machine 100 may, via an input signal at an operator interface, direct controller 106 to activate a component (e.g., lights or a heating element) of machine 100. In response to the operator input, controller 106 may send a switch signal to a coil (not shown) associated with relay switch decoupler 200 and used for operating the component. The switch signal provided to the coil may result in a magnetic field attracting an armature (not shown) associated with the coil. It is contemplated that the movable contact 202 may be mechanically coupled to the armature. Thus, the attraction may be used to couple the movable contact 202 with the fixed contact 204. The coupling of the movable contact 202 with the fixed contact 204 may allow power to flow from power source 102 to a load 104 that may be associated with the component, thus activating the component.

It is further contemplated that in response to the operator input, controller 106 may set and store in its internal memory a first logic value indicating that the switch signal is turned on. Controller 106 may further set and store in its internal memory a second logic value indicating that the load 104 is receiving power. In some embodiments, the first and second logic values may have a low (i.e., off) state and a high (i.e., on) state. The low state may be represented by a DC voltage set below 2.5 volts (e.g., 0 volts DC). The high state may be represented by a DC voltage set above 2.5 volts (e.g., 5 volts DC).

To discontinue supplying power to load 104 (e.g., the operator directs controller 106 to turn off the component), controller 106 may discontinue the switch signal, resulting in the interruption of the magnetic field, and the movable contact 202 being returned to its relaxed state. In addition to turning off the switch signal, controller 106 may set and store in its internal memory the first logic value to its original state. For example, since the switch signal is turned off, controller 106 may set and store in its internal memory the first logic value to a low state.

Controller 106 may further monitor the power available to load 104 (Step 304). In some embodiments, controller 106 may query a sensor (not shown) disposed at or near the output of relay switch decoupler 200 to monitor power available to load 104. If power is available to load 104, controller 106 may set and store in its internal memory the second logic value to a high state. If power is not available to load 104, controller 106 may set and store in its internal memory the second logic value to a low state. Controller 106 may also monitor the switch signal associated with the relay switch decoupler 200 (Step 306). As described previously, if the switch signal is on, indicating that relay switch decoupler 200 should be “on” (i.e., electrically coupling power source 102 to load 104), controller 106 may set and store in its internal memory the first logic value to a high state. If the switch signal is off, indicating that the relay device should not be operating to provide power to load 104, controller 106 may set and store in its internal memory the first logic value to a low state.

Controller 106 may then compare the monitored power available to load 104 with the monitored state of the switch signal (Step 308) to detect a short-circuit failure of relay switch decoupler 200. As explained, a short circuit failure is identified if relay switch decoupler 200 is set to an “off” state (i.e., movable contact 202 should be disconnected from fixed contact 204, thereby prohibiting power flow to load 104), but a significant amount of power is available to load 104. In one embodiment, controller 106 may compare the first logic value (indicative of the status of a switch signal) to the second logic value (indicative of the power available to load 104). If the first logic value is in a low state (indicating that the switch signal is turned off), and if the second logic value is in a high state (indicating that power is available to load 104), controller 106 may provide a control signal to actuator 208 (Step 310).

If controller 106 does provide the control signal to actuator 208, actuator 208 will be activated causing insulating decoupler 206 to decouple power source 102 and load 104. In the embodiment of FIG. 2, the activation of actuator 208 may result in insulating decoupler 206 being forced against movable contact 202, thus disconnecting movable contact 202 from fixed contact 204 and breaking the electrical coupling of power source 102 and load 104. It is contemplated that relay switch decoupler 200 may have its own controller. In this embodiment, the controller located at relay switch decoupler 200 may work together with controller 106, or perform the functions of controller 106 listed above associated with relay switch decoupler 200 on its own.

Certain embodiments of the present disclosure may include providing an indication of the status of relay switch decoupler 200 (Step 312). According to one embodiment, relay switch decoupler 200 may provide a status indication signal to an electronic control module (ECM) of machine 100. If the status indication signal indicates a problem (e.g., indicating that actuator 208 was activated and that relay switch decoupler 200 needs to be replaced) with relay switch decoupler 200, the ECM may trigger an alarm on the operator console of machine. Alternatively or additionally, it is contemplated that an alert may be provided directly to the operator of machine 100 via an audible, visual, or combination audible/visible alarm located on the operator console. It will be understood that the steps in flowchart 300 may be implemented in any suitable manner such as, for example, continuously, periodically, individually repeated, etc.

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims.

What is claimed is:

1. A relay switch decoupler, comprising:
a first contact;
a second contact selectively coupled to the first contact;
an insulating decoupler situated proximate to the first contact and the second contact; and
an actuator coupled to the insulating decoupler and configured to cause the insulating decoupler to decouple the first contact from the second contact in response to a control signal.

2. The relay switch decoupler of claim 1, further including a controller configured to provide the control signal to the actuator.

3. The relay switch decoupler of claim 2, wherein the controller is further configured to:
monitor a power available to a load;
monitor a switch signal associated with a relay switch; and
compare the monitored power available to the load with the monitored switch signal, and based on the comparison, selectively provide the control signal to the actuator.

4. The relay switch decoupler of claim 3, wherein the monitored power available to the load and the monitored switch signal are logic values set according to a state of the power available to the load and a state of the switch signal, respectively.

5. The relay switch decoupler of claim 2, wherein the controller is further configured to:
monitor a power available to a load;
monitor a switch signal associated with a relay switch; and
provide the control signal to the actuator if the switch signal is below a first threshold value and the power available to the load is above a second threshold value.

6. The relay switch decoupler of claim 2, wherein the actuator includes a compartment filled with a pyrotechnic powder, the control signal is configured to cause ignition of the pyrotechnic powder, and the ignition of the pyrotechnic powder produces a force that causes the insulating decoupler to decouple the first contact from the second contact.

7. The relay switch decoupler of claim 2, wherein the actuator is a compressed spring coupled to the insulating decoupler, the compressed spring is configured to be released from a compressed state in response to the control signal, and the releasing of the compressed spring results in a force that causes the insulating decoupler to decouple the first contact from the second contact.

8. The relay switch decoupler of claim 1, wherein the insulating decoupler comprises a substantially non-conductive material.

9. A method for decoupling a power source from a load, the method comprising:
monitoring a power available to the load;
monitoring a switch signal associated with a relay switching system; and
selectively providing a control signal to an actuator, wherein the actuator is configured to cause an insulating decoupler to decouple the power source from the load in response to the control signal.

10. The method of claim 9, wherein selectively providing the control signal to the actuator further includes:
comparing the monitored power available to the load with the monitored switch signal; and
providing the control signal to the actuator if the switch signal is off and power is available to the load.

11. The method of claim 9, wherein selectively providing the control signal to the actuator further includes providing the control signal when the switch signal is below a first threshold value and the power available to the load is above a second threshold value.

12. The method of claim 9, wherein selectively providing the control signal to the actuator further includes:
setting a first logic value corresponding to the monitored switch signal associated with the relay switching system;
setting a second logic value corresponding to the monitored power available to the load;
comparing the first logic value with the second logic value; and
providing the control signal to the actuator if the first logic value and the second logic value are in different states.

13. A relay switching system comprising:
a power source;
a load; and
a relay switch configured to electrically couple the power source to the load, the relay switch comprising:
an insulating decoupler; and
an actuator coupled to the insulating decoupler and configured to cause the insulating decoupler to decouple the power source from the load in response to a control signal.

14. The system of claim 13, further including a controller configured to provide the control signal to the actuator.

15. The system of claim 14, wherein the controller is further configured to:
monitor a power available to the load;
monitor a switch signal associated with the relay switch; and
provide the control signal to the actuator if the switch signal is below a first threshold value and the power available to the load is above a second threshold value.

16. The system of claim 14, wherein the controller is further configured to:
monitor a power available to the load;
monitor a switch signal associated with the relay switch; and
compare the monitored power available to the load with the monitored switch signal, and based on the comparison, selectively provide the control signal to the actuator.

17. The system of claim 16, wherein the monitored power available to the load and the monitored switch signal are logic values set according to a state of the power available to the load and a state of the switch signal, respectively.

18. The system of claim 13, wherein the actuator is a compartment filled with a pyrotechnic powder, the control signal is configured to cause ignition of the pyrotechnic powder, and the ignition of the pyrotechnic powder produces a force that causes the insulating decoupler to decouple the power source from the load.

19. The system of claim 13, wherein the actuator is a compressed spring coupled to the insulating decoupler, the compressed spring is configured to be released from a compressed state in response to the control signal, and the releasing of the compressed spring results in a force that causes the insulating decoupler to decouple the power source from the load.

20. The system of claim 13, wherein the insulating decoupler comprises a substantially non-conductive material.
